(19) United States
(12) Patent Application Publication
(10) Pub. No.: US 2026/0267779 A1
(43) Pub. Date: Sep. 10, 2026

(54) LOW POWER SYSTEM AND METHOD FOR GENERATING A STORY FROM A NATURAL LANGUAGE INPUT WITH REDUCED TESTING

(71) Applicant: JPMorgan Chase Bank, N.A., New York, NY (US)

(72) Inventors: Varun MONGA, Bengaluru (IN); Kevin ENDRES, Narberth, PA (US); Ashish LAMICHHANE, Glen Mills, PA (US); Nada ZIAB, Wilmington, DE (US)

(73) Assignee: JPMorgan Chase Bank, N.A., New York, NY (US)

(21) Appl. No.: 19/548,083

(22) Filed: Feb. 24, 2026

(30) Foreign Application Priority Data
Mar. 4, 2025 (IN) 202511019059

(51) Int. Cl. G06F 11/3668

(52) U.S. Cl. CPC G06F 11/3684

(57) ABSTRACT

A system and method are provided for generating a story from a natural language input. The methodology includes: receiving a natural language input including parameters of a story to be created; pre-processing the natural language input to create an LLM prompt; providing a selection option for the story to be created in a testable format or a non-testable format; generating, by an artificial intelligence or machine language model, the story based on the LLM prompt; generating, in response to at least selection for the story to be in testable format, at least one acceptance test that validates the story has been completed; and validating the story against predetermined criteria.

### CROSS REFERENCE TO RELATED APPLICATIONS

This Application claims priority to India Provisional Patent Application No. 202511019059 entitled SYSTEM AND METHOD FOR GENERATING A STORY FROM A NATURAL LANGUAGE INPUT WITH REDUCED TESTING filed Mar. 4, 2025, the contents of which are expressly incorporated herein by reference.

### TECHNICAL FIELD

This disclosure relates to methods and apparatuses for using an artificial intelligence / machine learning (AI/ML) model to generate a story from a natural language input, where the story generation requires reduced testing via a methodology that reduces the power requirements needed to generate the story.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

There is a general interest in being able to develop stories (e.g., goals, process flows, marketing messages). However, the traditional process to generate stories are challenging. The process is largely manual as creating user stories in software development demands significant manual input, which can be resource-intensive. The process requires extensive collaboration among team members, often leading to inefficiencies. Multiple meetings are needed to ensure user stories are well-defined and align with project requirements, prolonging the development timeline. Ensuring that user stories meet project standards and requirements can be challenging and labor-intensive. There is an interest in a methodology that can automate the creation of user stories, reducing time and effort while maintaining or enhancing quality.

The traditional approaches have several technical problems. A first problem is that the process is highly subjective. When the framework of the story is first created, the story is a subjective expression of what the creator wants to happen, but different creators might express the story differently. The process simply lacks a uniform objective standard. A second problem is that the story creator may not provide enough detail for the story. When the story is in a testable format, it is also unclear during later testing whether any error was due to the story or the missing content, and additional testing is required to isolate the source of the error. The repeated testing consumes a great deal of computer resources and electrical power, and takes a great deal of time.

Indeed, large language models (and all AI inputs generally) require substantial computational resources to generate outputs, including processor cycles, memory access operations, and large-scale data movement, all of which consume significant electrical power. In conventional systems, when an LLM produces an unsatisfactory, incomplete, or noncompliant result, the output must be reviewed and the corresponding input modified or refined before resubmitting the request to the LLM. This iterative trial-and-error process often requires multiple LLM executions to achieve an acceptable result.

Each repeated execution increases overall system workload and results in cumulative electrical power consumption that scales with the number of iterations. Additionally, intermediate processing steps such as output validation, testing, formatting, and retranslation further amplify resource usage. As LLM-based systems are deployed at scale, these repeated regeneration cycles contribute to inefficiencies, increased operational costs, and unnecessary energy consumption. Accordingly, there exists a technical problem in reducing electrical power usage associated with repeated LLM invocations in the story generation process caused by unsatisfactory initial outputs and subsequent input adjustments. Simply stated, completing the story generation in one or two rounds of LLM submissions consumes far less power than ten rounds of LLM submissions.

There is accordingly an interest in reducing power consumption in the story generating process by reducing the number of LLM submissions. Any such solution to the extent it uses artificial intelligence (AI) and/or machine learning (ML) grapples with the underlying electrical power requirements and computer resources to implement. A typical inquiry to general AI consumes on the order of ten times the amount of electrical power as a comparable Google search. OpenAI CEO Sam Altman recently stated that the company spends tens of millions of dollars on electricity costs because people say “please” and “thank you” to ChatGPT. The growth of AL/ML has become an industry wide technical problem in the provision of power to support AI/ML. The recent activity by Microsoft to obtain access to power from the Three Mile Island nuclear facility is an example of the industry wide need for power. Accordingly, any such technical solution should include features that reduce the overall power consumption of the story generating process.

### SUMMARY

The present disclosure, through one or more of its various aspects, embodiments, and/or specific features or sub-components, provides, among other features, various systems, servers, devices, methods, media, programs, and platforms for using an AI/ML model to generate a story from a natural language input in an accurate and efficient manner, where the story generation requires reduced testing.

According to an embodiment, a method is disclosed. The method includes: receiving a natural language input including parameters of a story to be created; pre-processing the natural language input to create an LLM prompt; providing a selection option for the story to be created in a testable format or a non-testable format; generating, by an artificial intelligence or machine language model, the story based on the LLM prompt; generating, in response to at least selection for the story to be in testable format, at least one acceptance test that validates the story has been completed; and validating the story against predetermined criteria.

The above embodiment may have various features. The pre-processing may be through a software model that is pre-trained on company-specific acronyms, company-specific standards, and company-specific terminology. The pre-processing may include identifying, within the natural language input, content referenced in the natural language input for which corresponding details are absent from the natural language input, obtaining the corresponding details, and populating the LLM prompt with the obtained corresponding details. The generating a story may include creating a raw story in response to at least the LLM prompt, identifying at least one content field in a project management format that is not present in the raw story; adding, to the raw story, content that corresponds to the identified at least one content field; and translating the raw story into a project management format. The testable format may be a Gherkin story. The method may further include receiving, in response to at least the providing, a selected format of the story to be in the testable format or the non-testable format, and the generating a story comprises generating the story in the selected format. The predetermined criteria may include the story meets all parameters of the natural language input as pre-processed, improvements as required by the pre-processing have been met, and/or a checklist of all subprocesses to be performed for the story have been completed.

According to another embodiment, a system is provided. The system includes a processor and a memory storing instructions programmed to cooperate with the processor to cause the processor to perform operations. The operations include: receiving a natural language input including parameters of a story to be created; pre-processing the natural language input to create an LLM prompt; providing a selection option for the story to be created in a testable format or a non-testable format; generating, by an artificial intelligence or machine language model, the story based on the LLM prompt; generating, in response to at least selection for the story to be in testable format, at least one acceptance test that validates the story has been completed; and validating the story against predetermined criteria.

The above embodiment may have various features. The pre-processing may be through a software model that is pre-trained on company-specific acronyms, company-specific standards, and company-specific terminology. The pre-processing may include identifying, within the natural language input, content referenced in the natural language input for which corresponding details are absent from the natural language input, obtaining the corresponding details, and populating the LLM prompt with the obtained corresponding details. The generating a story may include creating a raw story in response to at least the LLM prompt, identifying at least one content field in a project management format that is not present in the raw story; adding, to the raw story, content that corresponds to the identified at least one content field; and translating the raw story into a project management format. The testable format may be a Gherkin story. The operations may further include receiving, in response to at least the providing, a selected format of the story to be in the testable format or the non-testable format, and the generating a story comprises generating the story in the selected format. The predetermined criteria may include the story meets all parameters of the natural language input as pre-processed, improvements as required by the pre-processing have been met, and/or a checklist of all subprocesses to be performed for the story have been completed.

According to another embodiment, a non-transitory computer readable media is provided. The media stores instructions programmed to cooperate with the processor to cause the processor to perform operations. The operations include: receiving a natural language input including parameters of a story to be created; pre-processing the natural language input to create an LLM prompt; providing a selection option for the story to be created in a testable format or a non-testable format; generating, by an artificial intelligence or machine language model, the story based on the LLM prompt; generating, in response to at least selection for the story to be in testable format, at least one acceptance test that validates the story has been completed; and validating the story against predetermined criteria.

The above embodiment may have various features. The pre-processing may be through a software model that is pre-trained on company-specific acronyms, company-specific standards, and company-specific terminology. The pre-processing may include identifying, within the natural language input, content referenced in the natural language input for which corresponding details are absent from the natural language input, obtaining the corresponding details, and populating the LLM prompt with the obtained corresponding details. The generating a story may include creating a raw story in response to at least the LLM prompt, identifying at least one content field in a project management format that is not present in the raw story; adding, to the raw story, content that corresponds to the identified at least one content field; and translating the raw story into a project management format. The testable format may be a Gherkin story. The operations may further include receiving, in response to at least the providing, a selected format of the story to be in the testable format or the non-testable format, and the generating a story comprises generating the story in the selected format. The predetermined criteria may include the story meets all parameters of the natural language input as pre-processed, improvements as required by the pre-processing have been met, and/or a checklist of all subprocesses to be performed for the story have been completed.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using an AI/ML model in accordance with an embodiment.

FIG. 2 illustrates an exemplary diagram of a network environment with a device for using an AI/ML model in accordance with an embodiment.

FIG. 3 illustrates a system diagram for implementing a method for using an AI/ML model in accordance with an embodiment.

FIG. 4 illustrates an exemplary flow chart of a process for using an AI/ML model to generate a story from a natural language input in an accurate and efficient manner, where the story generation requires reduced testing, in accordance with an embodiment.

FIG. 5 illustrates an exemplary flow chart of a process for using an AI/ML model to generate a story from a natural language input in an accurate and efficient manner, where the story generation requires reduced testing, in accordance with an embodiment.

FIG. 6 illustrates a data flow that corresponds to a process for using an AI/ML model to generate a story from a natural language input in an accurate and efficient manner, where the story generation requires reduced testing, in accordance with an embodiment.

FIG. 7 illustrates a data flow that corresponds to a process for using an AI/ML model to generate a story from a natural language input in an accurate and efficient manner, where the story generation requires reduced testing, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

The traditional approaches to generating stories have several technical problems. A first problem is that the process is highly subjective. When the framework of the story is first created, the story is a subjective expression of what the creator wants to happen, but different creators might express the story differently. A second problem is that the story creator may not provide enough detail for the story. The process simply lacks a uniform objective standard. When the story is in a testable format, it is also unclear during later testing whether any error was due to the story or the missing content, and additional testing is required to isolate the source of the error. The repeated testing consumes a great deal of computer resources and electrical power, and takes a great deal of time.

To address these technical problems, a methodology is disclosed. The methodology includes: receiving a natural language input including parameters of a story to be created; pre-processing the natural language input to create an LLM prompt; providing a selection option for the story to be created in a testable format or a non-testable format; generating, by an artificial intelligence or machine language model, the story based on the LLM prompt; validating the story against predetermined criteria; and testing the validated story in response to selection for the story to be in testable format.

The above methodology provides a technical solution to the technical problems of the traditional methods.

First, a user subjective establishment of story is replaced with company-specific acronyms, company-specific standards, and company-specific terminology of the story per the pre-processing, which reduces the effect of subjective considerations in the final story.

Second, preprocessing of story inputs to incorporate company-specific acronyms, standards, and terminology provides a technical improvement to the operation of a story creation artificial intelligence system and results in reduced electrical power consumption. In particular, the story creation engine is pre-programmed with a domain-specific lexicon that enables it to accurately interpret specialized input content and to generate a large language model (LLM) prompt that is semantically aligned with company-specific requirements prior to submission to the LLM.

By embedding such company-specific terminology and standards into the prompt generation process, the system reduces ambiguity and misinterpretation that would otherwise arise if generic or non-standard language were provided directly to the LLM. This preprocessing step increases the likelihood that the LLM produces an output that conforms to the intended domain constraints and formatting expectations on an initial execution.

As a result, the number of iterative prompt refinements and repeated LLM invocations is reduced. Each invocation of an LLM requires substantial computational resources, including processor cycles, memory access, and associated electrical power consumption. By limiting the production of unsatisfactory or non-compliant outputs that would necessitate re-submission of modified prompts, the system decreases total computational workload and energy usage.

Furthermore, the reduction in iterative cycles shortens overall processing time and minimizes token generation and evaluation overhead within the LLM. This contributes to improved computational efficiency at both the system and infrastructure levels, particularly when deployed at scale across multiple story generation tasks.

Accordingly, the preprocessing mechanism constitutes a technical optimization that enhances prompt accuracy, improves output reliability, and measurably reduces electrical power consumption by minimizing redundant LLM executions, thereby providing a tangible improvement to the functioning of computer-implemented story generation systems.

Third, as the pre-processing obtains and populates the LLM prompt with any missing information, the probability of errors in the testing process is much lower, which reduces the number of tests and corresponding drains on computer resources and electrical power. By supplying a complete and internally consistent prompt to the LLM, the system materially increases the likelihood that the resulting output satisfies predefined testing, validation, and quality criteria on an initial generation.

This improvement in prompt completeness reduces the incidence of errors detected during subsequent testing processes, such as logical inconsistencies, missing narrative elements, or noncompliance with required constraints. Consequently, the number of test executions and validation cycles performed on LLM-generated outputs is reduced.

In the absence of such preprocessing, unsatisfactory outputs would require repeated iterations in which prompts are manually or programmatically adjusted and resubmitted to the LLM. Each iteration incurs additional computational overhead, including repeated model inference, token processing, memory access, and test execution, all of which consume electrical power.

By lowering the probability of generating unsatisfactory outputs and reducing the need for iterative prompt refinement and retesting, the preprocessing mechanism decreases total LLM invocation frequency and testing workload. This results in a measurable reduction in processor utilization, runtime duration, and associated electrical power consumption. Accordingly, the preprocessing functionality provides a technical improvement that enhances system efficiency and reduces energy usage in computer-implemented story generation systems.

Fourth, the process takes only a fraction of time, in what took weeks or months to generate a story can now be performed in hours.

Fifth, by identifying any content in the fields of the project management tool that are not found in the raw story, and then adding that content to the raw story before translation reduces power consumption and speeds along the overall process. Creating a raw story and subsequently identifying at least one content field in a project management format that is not present in the raw story enables a staged validation and completion process that improves computational efficiency. Rather than repeatedly invoking the LLM to regenerate an entire story until all required project management fields are satisfied, the system performs a targeted analysis of the initially generated raw story to detect specific omissions.

By identifying the at least one missing content field and adding content corresponding to the identified field directly to the raw story, this selective augmentation avoids unnecessary regeneration of content that is already compliant, thereby reducing the scope of processing required to achieve a complete and valid output. Translation after required fields have been populated reduces the likelihood of translation errors or validation failures that would otherwise require re-execution of the translation process or additional LLM invocations.

In contrast to systems that iteratively regenerate entire outputs through repeated LLM executions, the process minimizes the number of full model inferences, token generation operations, and downstream validation cycles. Each avoided LLM invocation and translation pass reduces processor utilization, memory access operations, and execution time, resulting in lower aggregate electrical power consumption.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented.

The terms “substantial”, “substantially” or the like are defined to be essentially conforming to the particular dimension, shape, or other feature that the term modifies, such that the component need not be exact. For example, “substantially cylindrical” means that the object resembles a cylinder, but can have one or more deviations from a true cylinder. The terms are used as a modifier to imply “approximate” rather than “perfect.” It is a term of approximation, not a term of degree.

The term "comprising" when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ± 5% may be expected.

“First,” “second,” etc., re labels to distinguish components or blocks of otherwise similar names, but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

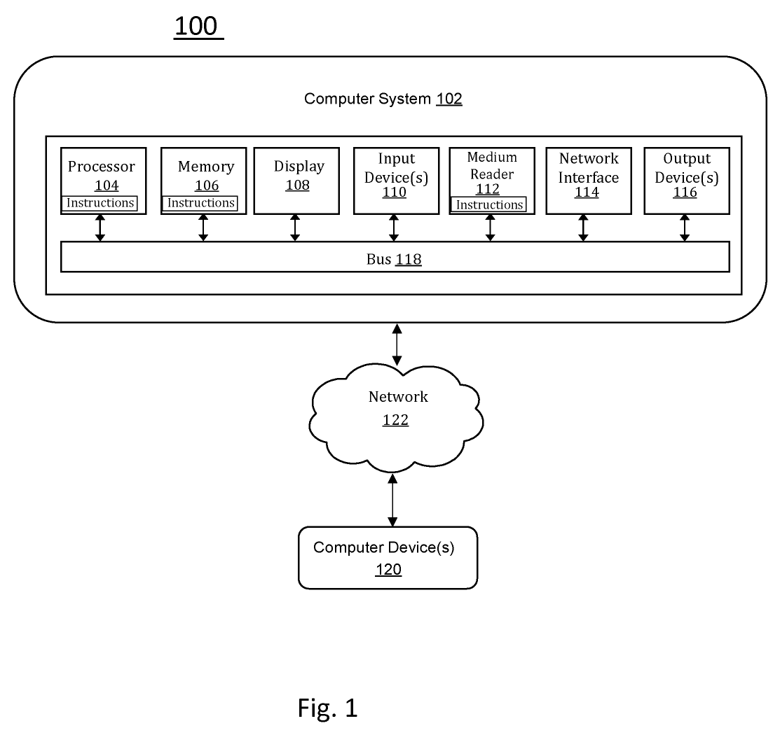

FIG. 1 is an exemplary system 100 for use in implementing a method for using an AI/ML model to generate a story from a natural language input in an accurate and efficient manner, where the story generation requires reduced testing, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain’t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

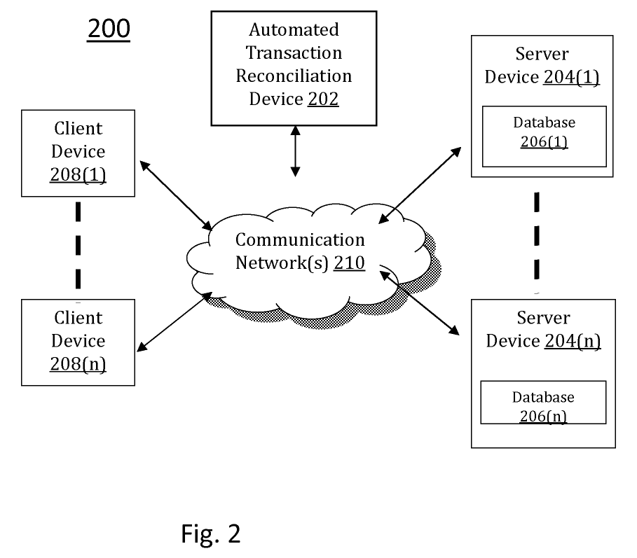

Referring to FIG. 2, a schematic of an exemplary network environment 200 for implementing a story generator device from natural language input (SGFNLID) of the instant disclosure is illustrated.

In some embodiments, the above-described problems associated with conventional tools may be overcome by implementing an SGFNLID 202 as illustrated in FIG. 2 that may be configured for implementing a method for using an AI/ML model to generate a story from a natural language input in an accurate and efficient manner, where the story generation requires reduced testing, but the disclosure is not limited thereto.

The SGFNLID 202 may have one or more computer system 102s, as described with respect to FIG. 1, which in aggregate provide the necessary functions.

The SGFNLID 202 may store one or more applications that can include executable instructions that, when executed by the SGFNLID 202, cause the SGFNLID 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SGFNLID 202 itself, may be located in virtual server(s) running in a cloud-based computing environment rather than being tied to one or more specific physical network computing devices. Also, the application(s) may be running in one or more virtual machines (VMs) executing on the SGFNLID 202. Additionally, in one or more embodiments of this technology, virtual machine(s) running on the SGFNLID 202 may be managed or supervised by a hypervisor.

In the network environment 200 of FIG. 2, the SGFNLID 202 is coupled to a plurality of server devices 204(1)-204(n) that hosts a plurality of databases 206(1)-206(n), and also to a plurality of client devices 208(1)-208(n) via communication network(s) 210. A communication interface of the SGFNLID 202, such as the network interface 114 of the computer system 102 of FIG. 1, operatively couples and communicates between the SGFNLID 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SGFNLID 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SGFNLID 202 may be a standalone device or integrated with one or more other devices or apparatuses, such as one or more of the server devices 204(1)-204(n), for example. In one particular example, the SGFNLID 202 may be hosted by one of the server devices 204(1)-204(n), and other arrangements are also possible. Moreover, one or more of the devices of the SGFNLID 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SGFNLID 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the SGFNLID 202 that may efficiently provide a platform for implementing a method for using an AI/ML model to generate a story from a natural language input in an accurate and efficient manner, where the story generation requires reduced testing, but the disclosure is not limited thereto.

The client devices 208(1)-208(n) may run interface applications, such as standard web browsers or standalone client applications, which may provide an interface to communicate with the SGFNLID 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the SGFNLID 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the SGFNLID 202, the server devices 204(1)-204(n), or the client devices 208(1)-208(n), for example, may be configured to operate as virtual instances on the same physical machine. For example, one or more of the SGFNLID 202, the server devices 204(1)-204(n), or the client devices 208(1)-208(n) may operate on the same physical device rather than as separate devices communicating through communication network(s) 210. Additionally, there may be more or fewer SGFNLIDs 202, server devices 204(1)-204(n), or client devices 208(1)-208(n) than illustrated in FIG. 2. In some embodiments, the SGFNLID 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

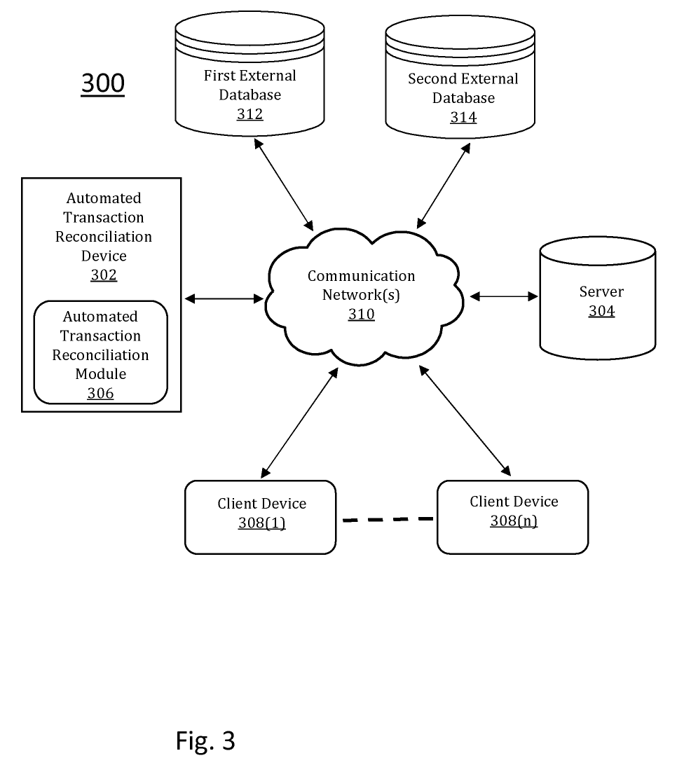

FIG. 3 illustrates a system diagram for implementing an SGFNLID 302 having an story generator from natural language input module (SGFNLIM), in accordance with an embodiment.

As illustrated in FIG. 3, the system 300 may include an SGFNLID 302 within which an SGFNLIM 306 is embedded, a server 304, a first external database 312, a second external database 314, a plurality of client devices 308(1) … 308(n), and a communication network 310.

In some embodiments, the SGFNLID 302 including the SGFNLIM 306 may be connected to the server 304, and the database(s) 312 via the communication network 310. The SGFNLID 302 may also be connected to the plurality of client devices 308(1) … 308(n) via the communication network 310, but the disclosure is not limited thereto.

In an embodiment, the SGFNLID 302 is described and shown in FIG. 3 as including the SGFNLIM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the SGFNLIM 306 may be configured to receive real-time feed of data from the plurality of client devices 308(1) … 308(n) and secondary sources via the communication network 310.

The plurality of client devices 308(1) … 308(n) are illustrated as being in communication with the SGFNLID 302. In this regard, the plurality of client devices 308(1) … 308(n) may be “clients” (e.g., customers) of the SGFNLID 302 and are described herein as such. Nevertheless, it is to be known and understood that the plurality of client devices 308(1) … 308(n) need not necessarily be “clients” of the SGFNLID 302, or any entity described in association therewith herein. Any additional or alternative relationship may exist between either or both of the plurality of client devices 308(1) … 308(n) and the SGFNLID 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) … 308(n) may communicate with the SGFNLID 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The SGFNLID 302 may be the same or similar to the SGFNLID 202 as described with respect to FIG. 2, including any features or combination of features described with respect thereto.

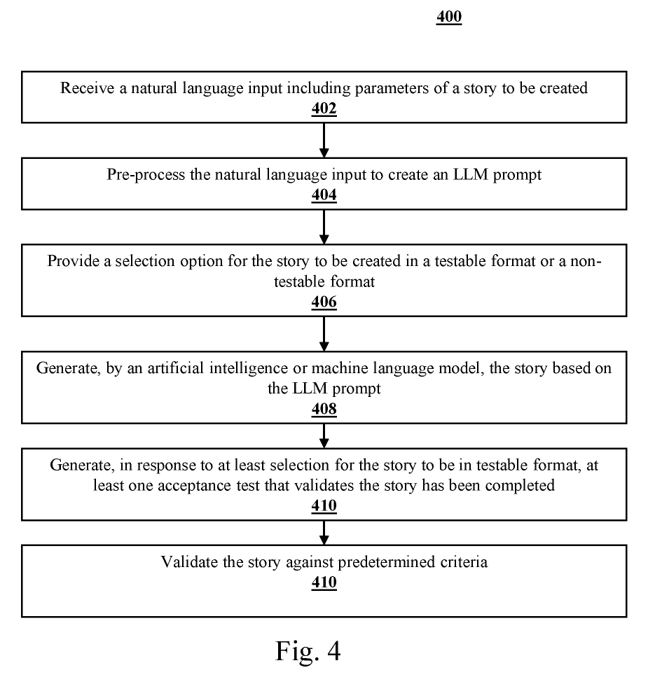

FIG. 4 illustrates an exemplary flow chart of a process 400 implemented by the SGFNLIM 306 of FIG. 3 for enablement of a system and a method for using an AI/ML model to generate a story from a natural language input in an accurate and efficient manner, where the story generation requires reduced testing and consumes less power, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include a step 402 of receiving a natural language input including parameters of a story to be created.

At step 404, the process 400 may include pre-processing the natural language input to create an LLM prompt.

At step 406, the process 400 may include providing a selection option for the story to be created in a testable format or a non-testable format.

At step 408, the process 400 may include generating, by an artificial intelligence or machine language model, the story based on the LLM prompt.

At step 410, the generating, in response to at least selection for the story to be in testable format, at least one acceptance test that validates the story has been completed.

At step 412, the process 400 may include validating the story against predetermined criteria.

At step 412, the process may include testing the validated story in response to selection for the story to be in testable format.

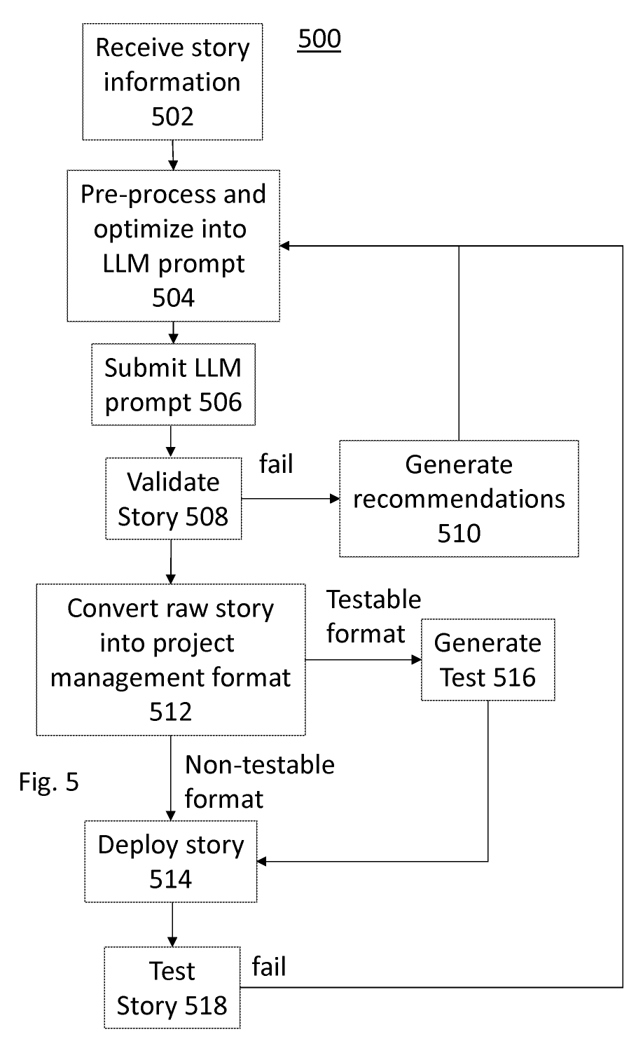

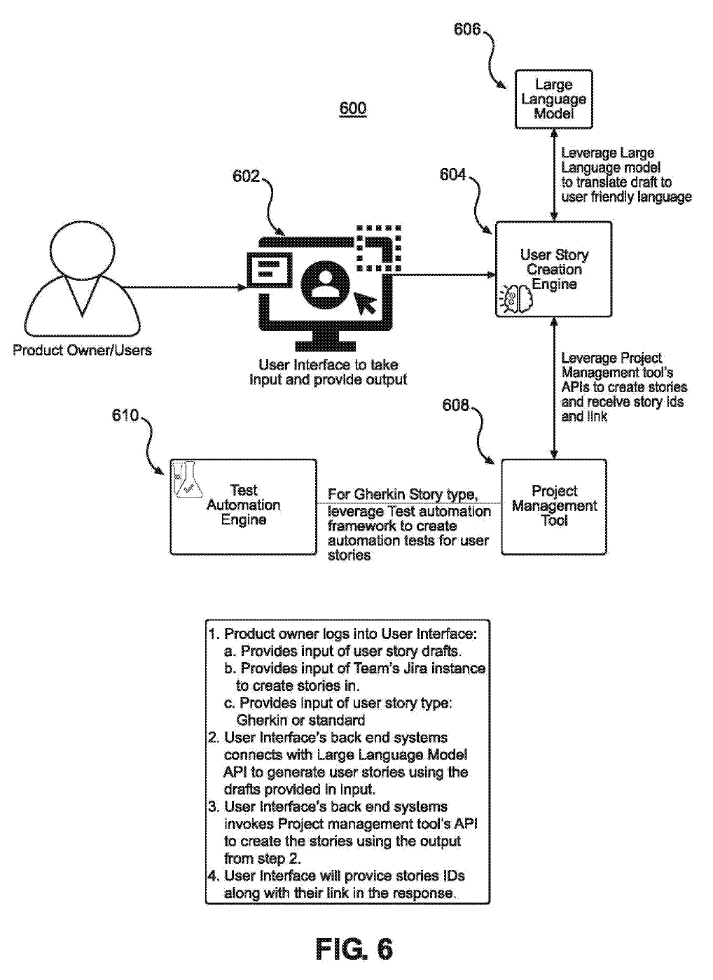

Referring now to FIGS. 5 and 6, a data flow 500 for an embodiment is shown. At step 502, the user enters information for the story into an interface 602. The story may be an Agile story, which is a brief, simple description of a feature or requirement written from the perspective of the end user or customer. The Agile story may follow the structure: As a [type of user], I want to [do something] so that I can [achieve a goal or benefit]. By way of non-limiting example, the story could be “As a customer, I want to view my order history so I can track past purchases.”

The information may include natural language input of story details, a project management format (e.g., JIRA), and whether the story format is to be in a testable format (e.g., Gherkin) or a non-testable format. The information may also include business specific information such as the name of a product that is part of the story, and who the story should be assigned to.

As part of step 502 and displayed on interface 602, the methodology provides a selection option for the story to be created in a testable format or a non-testable format. By way of non-limiting example, the methodology could prompt the user for a selection, “is story to be testable or non-testable format”. In another example, the prompt may simply be more generic “please submit relevant information” for which the user enters testable or non-testable as desired. The prompt could also be an unpopulated field, in which the user enters a natural language statement reflecting the format. The invention is not limited to how the methodology provides a selection option.

At step 504, a story creation engine 604, which may be an AI/ML, pre-processes and optimizes the information from 502 into an LLM prompt.

The story creation engine 604 pre-processing may include several features. A first feature is the story creation engine 604 is pre-programmed with company-specific acronyms, company-specific standards, and company-specific terminology, and can both interpret the same in the story input and incorporate the same into the LLM prompt. The story creation engine can add such company-specific acronyms, company-specific standards, and company-specific terminology into the LLM prompt, or change other information in the natural language input into such company-specific acronyms, company-specific standards, and company-specific terminology to incorporate into the LLM prompt.

Another feature is that the story creation engine 604 can identify, within the story input, content referenced in the natural language input for which corresponding details are absent from the natural language input, obtain the corresponding details, and populate the LLM prompt with the obtained corresponding details. By way of non-limiting example, if the input story is “migrate all alpha files from format A to format B” but did not further identify the alpha files, then the story creation engine 604 could locate the alpha files and include a corresponding link to the alpha files in the LLM prompt. In another non-limiting example, if format A and format B was company-specific jargon, then the story creation engine 604 could convert the jargon format into appropriate formal designations. In another non-limiting example, if the user failed to indicate testable/non-testable format at 502, then story creation engine 604 could prompt the user for that information.

Another feature is that the story creation engine 604 can validate the information against predefined standards to ensure that the story is something that the system could/should generate.

At step 506, the story creation engine 604 submits the LLM prompt to an appropriate AI/ML/LLM 606, which generates a raw story in the selected format.

At step 508, the story creation engine 604 validates the generated raw story relative to predetermined criteria, such as by way of non-limiting example acceptance criteria, value statements, and definition DONE.

Acceptance criteria is that the story performs as expected. For the input story “migrate all alpha files from format A to format B”, the acceptance criteria would be that the story dictates that the original format was A, the final format was B, and that all alpha files would be migrated.

Value statements are operational requirements as may have been included in the input story or added by pre-processing. Non-limiting examples would be “performance time must decrease from 100ms to 70s” or “reduce storage by 20%”.

Definition DONE is that a checklist of all expected sub-processes as needed for the story have been performed.

At step 510, if the validation fails for any reason relative to the predetermined criteria, then the story creation engine 604 may generate recommendations and/or receive user corrective input, and control returns to step 504 to create a new LLM prompt.

If validation is successful, then at step 512 the story creation engine 604 invokes a project management tool 608 to convert the raw story into a project management format, such as JIRA.

This occurs first by the project management tool 608 identifying any content in the fields of the project management tool that are not found in the story, and then adding that content to the raw story. By way of non-limiting example, the project management tool may have a Summary field for which the raw story includes no summary, so the project management tool will generate an appropriate summary and add it to the story content. This step may enrich the story with predetermined custom fields used by the project management format.

The project management tool 608 will then translate the raw story into an appropriate format for the project management tool 608.

If the story is in a non-testable format, the story is deployed at step 514. A link to the story may be sent to the user.

If the story is in a testable format, then at step 516 the testable story is sent to a test engine 610 for generation or identification of acceptance tests. The acceptance tests need to reflect the specific requirements of the story to ensure the validated story has been completed satisfactorily relative to defined criteria. Control returns to step 514, where a link to the test may be set to the user.

One the story is complete it may be submitted for testing at step 518. If the story was in testable format, this step could be applying the acceptance tests, or a different set of tests. If the test fails, then the methodology generates any corrective recommendations and/or receives user corrective input and control returns to an earlier point in the story creation, such as step 504.

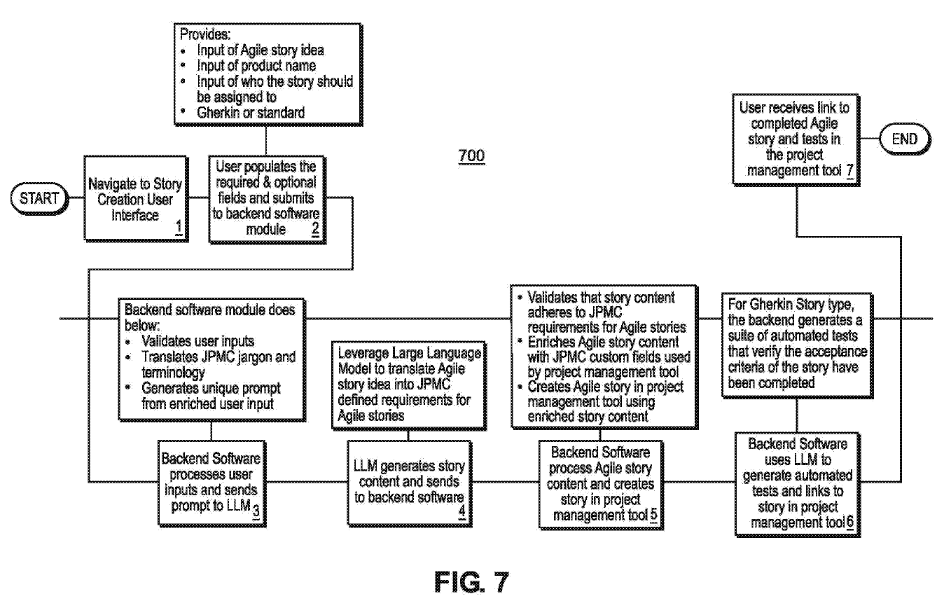

Referring now to FIG. 7, a dataflow 700 of another embodiment of the invention is shown.

The above methodology provides a technical solution to the technical problems of the traditional methods.

First, a user subjective establishment of story is replaced with company-specific acronyms, company-specific standards, and company-specific terminology of the story per the pre-processing, which reduces the effect of subjective considerations in the final story. This transformation reduces the subjective and interpretive nature of free-form natural language by converting variable expressions, colloquial phrases, and ambiguous descriptions into standardized, predefined representations.

Specifically, natural language inputs often allow multiple semantic interpretations, which can lead to inconsistent or unpredictable outputs when processed by a large language model. By mapping such inputs to company-specific terminology and standards that have fixed meanings and defined usage constraints, the system constrains the semantic space presented to the LLM. This results in a more objective, structured, and uniform prompt representation.

As a consequence, the LLM is guided to generate outputs that conform more consistently to established company standards and expectations, reducing variance across generated stories that are based on similar inputs. The reduction in subjectivity improves repeatability, predictability, and compliance of the generated output, thereby enhancing overall system reliability.

Accordingly, the incorporation and substitution of company-specific acronyms, standards, and terminology operates as a technical mechanism for normalizing natural language inputs into a more objective format, enabling the LLM to produce more consistent and standardized results across multiple executions that are consistent with objective standards rather than subject input.

Second, preprocessing of story inputs to incorporate company-specific acronyms, standards, and terminology provides a technical improvement to the operation of a story creation artificial intelligence system and results in reduced electrical power consumption. In particular, the story creation engine is pre-programmed with a domain-specific lexicon that enables it to accurately interpret specialized input content and to generate a large language model (LLM) prompt that is semantically aligned with company-specific requirements prior to submission to the LLM.

By embedding such company-specific terminology and standards into the prompt generation process, the system reduces ambiguity and misinterpretation that would otherwise arise if generic or non-standard language were provided directly to the LLM. This preprocessing step increases the likelihood that the LLM produces an output that conforms to the intended domain constraints and formatting expectations on an initial execution.

As a result, the number of iterative prompt refinements and repeated LLM invocations is reduced. Each invocation of an LLM requires substantial computational resources, including processor cycles, memory access, and associated electrical power consumption. By limiting the production of unsatisfactory or non-compliant outputs that would necessitate re-submission of modified prompts, the system decreases total computational workload and energy usage.

Furthermore, the reduction in iterative cycles shortens overall processing time and minimizes token generation and evaluation overhead within the LLM. This contributes to improved computational efficiency at both the system and infrastructure levels, particularly when deployed at scale across multiple story generation tasks.

Accordingly, the preprocessing mechanism constitutes a technical optimization that enhances prompt accuracy, improves output reliability, and measurably reduces electrical power consumption by minimizing redundant LLM executions, thereby providing a tangible improvement to the functioning of computer-implemented story generation systems.

Third, as the pre-processing obtains and populates the LLM prompt with any missing information, the probability of errors in the testing process is much lower, which reduces the number of tests and corresponding drains on computer resources and electrical power. By supplying a complete and internally consistent prompt to the LLM, the system materially increases the likelihood that the resulting output satisfies predefined testing, validation, and quality criteria on an initial generation.

This improvement in prompt completeness reduces the incidence of errors detected during subsequent testing processes, such as logical inconsistencies, missing narrative elements, or noncompliance with required constraints. Consequently, the number of test executions and validation cycles performed on LLM-generated outputs is reduced.

In the absence of such preprocessing, unsatisfactory outputs would require repeated iterations in which prompts are manually or programmatically adjusted and resubmitted to the LLM. Each iteration incurs additional computational overhead, including repeated model inference, token processing, memory access, and test execution, all of which consume electrical power.

By lowering the probability of generating unsatisfactory outputs and reducing the need for iterative prompt refinement and retesting, the preprocessing mechanism decreases total LLM invocation frequency and testing workload. This results in a measurable reduction in processor utilization, runtime duration, and associated electrical power consumption. Accordingly, the preprocessing functionality provides a technical improvement that enhances system efficiency and reduces energy usage in computer-implemented story generation systems.

Fourth, the process takes only a fraction of time, in what took weeks or months to generate a story can now be performed in hours.

Fifth, by identifying any content in the fields of the project management tool that are not found in the raw story, and then adding that content to the raw story before translation reduces power consumption and speeds along the overall process. Creating a raw story and subsequently identifying content field(s) in a project management format that is not present in the raw story enables a staged validation and completion process that improves computational efficiency. Rather than repeatedly invoking the LLM to regenerate an entire story until all required project management fields are satisfied, the system performs a targeted analysis of the initially generated raw story to detect specific omissions.

By identifying the at least one missing content field and adding content corresponding to the identified field directly to the raw story, this selective augmentation avoids unnecessary regeneration of content that is already compliant, thereby reducing the scope of processing required to achieve a complete and valid output. Translation after required fields have been populated reduces the likelihood of translation errors or validation failures that would otherwise require re-execution of the translation process or additional LLM invocations.

In contrast to systems that iteratively regenerate entire outputs through repeated LLM executions, the claimed process minimizes the number of full model inferences, token generation operations, and downstream validation cycles. Each avoided LLM invocation and translation pass reduces processor utilization, memory access operations, and execution time, resulting in lower aggregate electrical power consumption.

In some embodiments as disclosed above in FIGS. 1-7, technical improvements effected by the instant disclosure may include a platform to generate a story from a natural language input in an accurate and efficient manner, where the story generation requires reduced testing, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method, comprising:
receiving a natural language input including parameters of a story to be created;
pre-processing the natural language input to create an LLM prompt;
providing a selection option for the story to be created in a testable format or a non-testable format;
generating, by an artificial intelligence or machine language model, the story based on the LLM prompt;
generating, in response to at least selection for the story to be in testable format, at least one acceptance test that validates the story has been completed; and
validating the story against predetermined criteria.

2. The method of claim 1, wherein the pre-processing is through a software model that is pre-trained on company-specific acronyms, company-specific standards, and company-specific terminology.

3. The method of claim 1, wherein the pre-processing comprises:
identifying, within the natural language input, content referenced in the natural language input for which corresponding details are absent from the natural language input;
obtaining the corresponding details; and
populating the LLM prompt with the obtained corresponding details.

4. The method of claim 1, wherein the generating a story comprises:
creating a raw story in response to at least the LLM prompt;
identifying at least one content field in a project management format that is not present in the raw story;
adding, to the raw story, content that corresponds to the identified at least one content field; and
translating, after the adding, the raw story into a project management format.

5. The method of claim 1, wherein the at least one acceptance test is in Gherkin language.

6. The method of claim 1, further comprising:
receiving, in response to at least the providing, a selected format of the story to be in the testable format or the non-testable format; and
the generating a story comprises generating the story in the selected format.

7. The method of claim 1, wherein the predetermined criteria includes:
the story meets all parameters of the natural language input as pre-processed;
improvements as required by the pre-processing have been met; and/or
a checklist of all subprocesses to be performed for the story have been completed.

8. The method of claim 1, further comprising:
testing the validated story against the at least one acceptance test.

9. A system, comprising:
a processor;
a memory storing instructions programmed to cooperate with the processor to cause the processor to perform operations comprising:
receiving a natural language input including parameters of a story to be created;
pre-processing the natural language input to create an LLM prompt;
providing a selection option for the story to be created in a testable format or a non-testable format;
generating, by an artificial intelligence or machine language model, the story based on the LLM prompt;
generating, in response to at least selection for the story to be in testable format, at least one acceptance test that validates the story has been completed; and
validating the story against predetermined criteria.

10. The system of claim 9, wherein the pre-processing is through a software model that is pre-trained on company-specific acronyms, company-specific standards, and company-specific terminology.

11. The system of claim 9, wherein the pre-processing comprises:
identifying, within the natural language input, content referenced in the natural language input for which corresponding details are absent from the natural language input;
obtaining the corresponding details; and
populating the LLM prompt with the obtained corresponding details.

12. The system of claim 9, wherein the generating a story comprises:
creating a raw story in response to at least the LLM prompt;
identifying at least one content field in a project management format that is not present in the raw story;
adding, to the raw story, content that corresponds to the identified at least one content field; and
translating, after the adding, the raw story into a project management format.

13. The system of claim 9, wherein the testable format is a Gherkin story.

14. The system of claim 9, the operations further comprising:
receiving, in response to at least the providing, a selected format of the story to be in the testable format or the non-testable format; and
the generating a story comprises generating the story in the selected format.

15. The system of claim 9, wherein the predetermined criteria includes:
the story meets all parameters of the natural language input as pre-processed;
improvements as required by the pre-processing have been met; and/or
a checklist of all subprocesses to be performed for the story have been completed.

16. The system of claim 9, the operations further comprising:
testing the validated story against the at least one acceptance test.

17. A non-transitory computer readable media storing instructions programmed to cooperate with a processor to cause the processor to perform operations comprising:
receiving a natural language input including parameters of a story to be created;
pre-processing the natural language input to create an LLM prompt;
providing a selection option for the story to be created in a testable format or a non-testable format;
generating, by an artificial intelligence or machine language model, the story based on the LLM prompt;
validating the story against predetermined criteria; and
testing the validated story in response to selection for the story to be in testable format.

18. The non-transitory computer readable media of claim 17, wherein the pre-processing is through a software model that is pre-trained on company-specific acronyms, company-specific standards, and company-specific terminology.

19. The non-transitory computer readable media of claim 17, wherein the pre-processing comprises:
identifying, within the natural language input, content referenced in the natural language input for which corresponding details are absent from the natural language input;
obtaining the corresponding details; and
populating the LLM prompt with the obtained corresponding details.

20. The non-transitory computer readable media of claim 17, wherein the generating a story comprises:
creating a raw story in response to at least the LLM prompt;
identifying at least one content field in a project management format that is not present in the raw story;
adding, to the raw story, content that corresponds to the identified at least one content field; and
translating, after the adding, the raw story into a project management format.
